(19) United States
(12) Patent Application Publication
(10) Pub. No.: US 2017/0188214 A1
(43) Pub. Date: Jun. 29, 2017

(54) METHOD AND ELECTRONIC DEVICE FOR SHARING MULTIMEDIA INFORMATION

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Shan LIU, Beijing (CN)

(21) Appl. No.: 15/244,604

(22) Filed: Aug. 23, 2016

Related U.S. Application Data
(63) Continuation of application No. PCT/CN2016/088599, filed on Jul. 5, 2016.

(30) Foreign Application Priority Data
Dec. 29, 2015 (CN) 201511010238.3

(51) Int. Cl. H04W 4/20; H04L 12/58

(52) U.S. Cl. CPC H04W 4/206; H04L 51/32; H04L 51/10

(57) ABSTRACT

A method and an electronic device for sharing multimedia information, including: receiving a request for sharing multimedia information from a user; acquiring a number of sharing times of at least two social networking application software for sharing the multimedia information; and ranking the at least two social networking application softwares in an application list based on the number of sharing times of each of the at least two social networking application software and displaying the application list for the user to select.

### CROSS REFERENCE TO RELATED APPLICATIONS

This application is a continuation of a PCT application with an Application No. PCT/CN2016/088599, filed on Jul. 5, 2016, which claims priority to Chinese Patent Application No. 201511010238.3, filed on Dec. 29, 2015, entitled “Method for Sharing Multimedia Information and Apparatus”, which is incorporated herein by reference in its entirety.

### TECHNICAL FIELD

This application relates to the computer technology, for example, to a method and an electronic device for sharing multimedia information.

### BACKGROUND

With the development of smartphones, more and more social networking application software is running on the smartphones. A large number of users share multimedia information, such as text, music, pictures or videos via these social networking application software. In the process of sharing, a sharing control is usually used to select the social networking application software, and the selected social networking application software to complete the sharing of multimedia information.

In the related art, after the sharing control is clicked, all the social networking application software for sharing multimedia information can be listed on an intelligent terminal in a form of an application list, generally speaking, the social networking application software is usually ranked in a time sequence of the installation thereof, and the ranking manner is substantially fixed once formed. In the process of implementing this application, the inventor finds at least the following problems in the related art: with the increasing of the social networking application software installed by the user, the list will get longer, some least frequently used social networking application software, even never been used before, may rank at front positions of the application list, such that the user cannot select his frequently-used social networking application software at a first time, for sharing the multimedia information, resulting in a poor user experience.

### SUMMARY

This application provides a method and an electronic device for sharing multimedia information, to facilitate the user to select frequently-used social networking application software at a first time after clicking on a sharing control, for sharing the multimedia information.

In a first aspect, embodiments of this application provide a method for sharing multimedia information, which includes:

receiving a request for sharing multimedia information from a user;

acquiring a number of sharing times of at least two social networking application software for sharing the multimedia information; and

ranking the at least two social networking application software based on the number of sharing times of each of the at least two social networking application software and displaying the application list for the user to select.

In a second aspect, embodiments of this application also provide a non-transitory computer storage medium storing computer executable instructions, and when the instructions are executed by an electronic device, the electronic device is caused to perform any of the above-described methods for sharing multimedia information in this application.

In a third aspect, embodiments of this application also provide an electronic device, including: at least one processor, and a memory communicably connected with the at least one processor and for storing instructions executable by the at least one processor; wherein, the memory has stored thereon instructions executable by the at least one processor, and when executed by the at least one processor, the at least one processor is caused to perform any of the above-described methods for sharing multimedia information in this application.

### BRIEF DESCRIPTION OF DRAWINGS

One or more embodiments are illustrated with reference to pictures in the corresponding accompanying drawings, which is not intended to limit embodiments, the same reference numerals in the drawings indicate similar elements, and these drawings are not drawn to scale, unless otherwise specified.

FIG. 1 is a schematic flowchart of a method for sharing multimedia information according to Embodiment 1 of this application;

FIG. 2 is a schematic flowchart of a method for sharing multimedia information according to Embodiment 2 of this application;

FIG. 3 is a schematic flowchart of a method for sharing multimedia information according to Embodiment 3 of this application;

FIG. 4 is a schematic flowchart of a method for sharing multimedia information according to Embodiment 4 of this application;

FIG. 5 is a structurally schematic diagram of an apparatus for sharing multimedia information according to Embodiment 5 of this application;

FIG. 6 is a schematic flowchart of a method for sharing multimedia information according to Embodiment 6 of this application;

FIG. 7 is a schematic diagram of a first interface of an apparatus for sharing multimedia information according to Embodiment 7 of this application;

FIG. 8 is a schematic diagram of a second interface of an apparatus for sharing multimedia information according to Embodiment 7 of this application;

FIG. 9 is a schematic diagram of a third interface of an apparatus for sharing multimedia information according to Embodiment 7 of this application; and

FIG. 10 is a schematic diagram showing the structure of hardware of an electronic device for performing a method for sharing multimedia information according to Embodiment 9 of this application.

### DETAILED DESCRIPTION

Hereinafter, this application will be explained in more detail with reference to the accompanying drawings and embodiments. It should be understood that the embodiments described herein are only intended to be illustrative and not restrictive. It should be additionally understood that, for illustrative purposes, only those portions relevant to this application, not all the structures are shown in the accompanying drawings.

### Embodiment 1

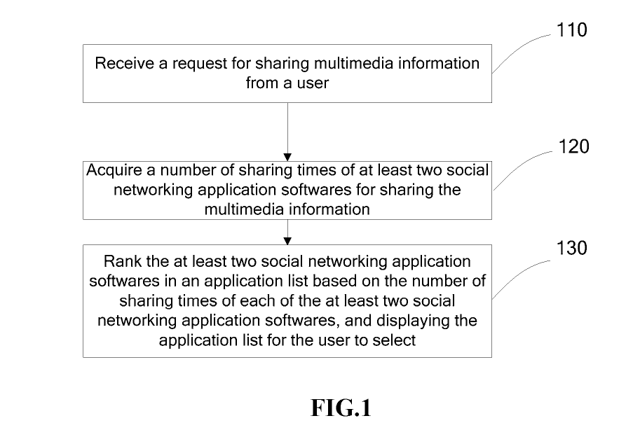

FIG. 1 is a schematic flowchart of a method for sharing multimedia information according to Embodiment 1 of this application, this embodiment is applicable to a case that the user needs to share multimedia information, and the method can be performed by an intelligent terminal, for example, an apparatus for sharing multimedia information installed on a smart phone, a tablet computer (portable android device, Pad), and can include the following steps of:

In Step 110, a request for sharing multimedia information is received from a user;

When the user needs to share multimedia information, such as pictures and videos, a sharing request is sent by clicking on a sharing control, and the apparatus for sharing multimedia information installed in the intelligent terminal receives the request.

In Step 120, a number of sharing times of at least two social networking application software for sharing the above multimedia information is acquired;

Particularly, the number of sharing times of each social networking application software is recorded in a database of the intelligent terminal, and the number of sharing times is the number of times of multimedia information shared by the social networking application software, for example, if picture information is shared ten times by WeChat, the number of sharing times of WeChat is ten.

In Step 130, the at least two social networking application software in an application list is ranked based on the number of sharing times of at least two social networking application software, and the application list is displayed for the user to select.

After the number of sharing times of each of the at least two social networking application software is acquired, the number of sharing times can be ranked in a high to low sequence, the social networking application software with the greatest number of sharing times is ranked at the frontmost, and the application list, which lists out icons of social networking application software according to a respective sequence for selection by the user, is displayed after completion of the ranking.

After aforementioned steps have been performed, the social networking application software selected by the user can be acquired; and one is added to the number of sharing times of the social networking application software selected by the user. The number of sharing times can be recorded in a database.

In embodiments of this application, the social networking application software in the application list selected by the user is not unique, and the user can simultaneously select a plurality of social networking application software to complete sharing of the same multimedia information in one time.

By adopting technical solutions according to Embodiment 1, social networking application software in the application list are ranked for the user to select, based on the number of sharing times, solving the problem of being not flexible enough since the application list is fixed, when the user shares the multimedia information, such that the user can select frequently-used social networking application software at a first time, for sharing the multimedia information.

### Embodiment 2

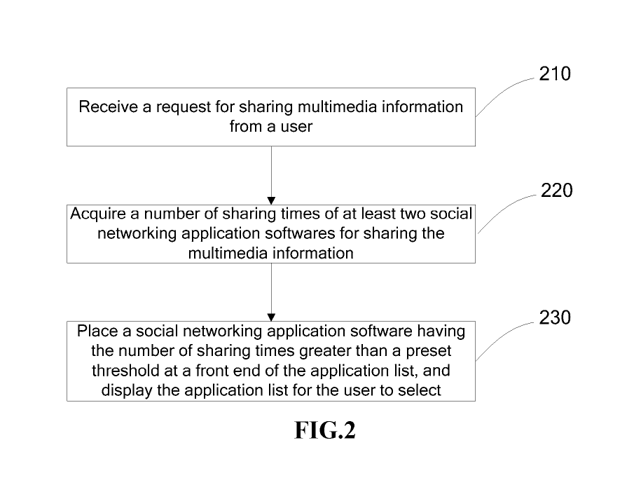

FIG. 2 is a schematic flowchart of a method for sharing multimedia information according to Embodiment 2 of this application, and the method includes:

In Step 210, a request for sharing multimedia information is received from a user;

In Step 220, the number of sharing times of at least two social networking application software for sharing the multimedia information is acquired;

In Step 230, social networking application software having the number of sharing times greater than a preset threshold is placed at a front end of the application list, and the application list is displayed for the user to select.

Particularly, the preset threshold is preset by a system or set by the user manually, in this step, only the social networking application software having the number of sharing times greater than the preset threshold can be ranked again and placed at the front end of the application list in a ranked sequence.

By adopting technical solutions according to Embodiment 2, the number of sharing times and the preset threshold are compared, only the social networking application software having the number of sharing times greater than the preset threshold can be ranked again and placed at the front end of the application list, solving the problem that some social networking application software have hardly been used before but ranked again, meanwhile, also solving the case that the application list changes frequently in an initial stage of using through the setting of the preset threshold.

### Embodiment 3

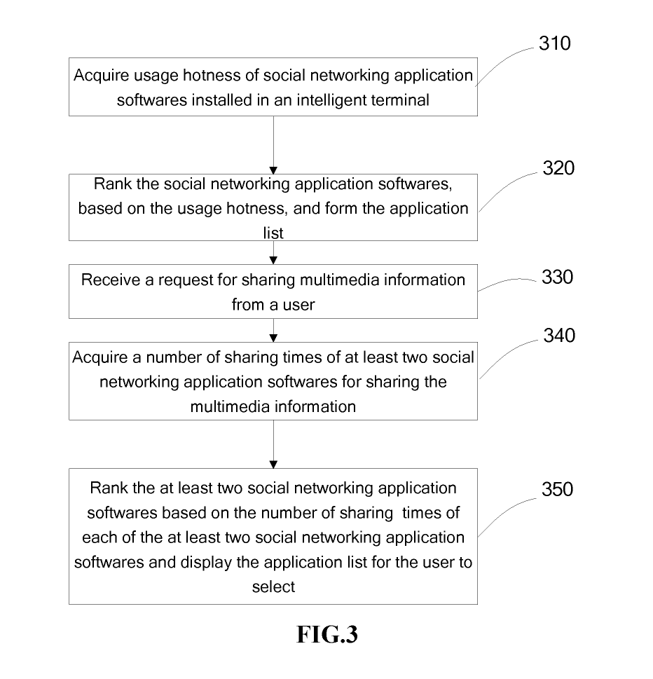

FIG. 3 is a schematic flowchart of a method for sharing multimedia information according to Embodiment 3 of this application, and the method includes:

In Step 310, usage hotness of social networking application software installed in an intelligent terminal is acquired;

Particularly, the usage hotness can be obtained by acquiring the number of sharing times of the social networking application software in multiple intelligent terminals, and can be acquired by a server and then sent to the intelligent terminal, wherein the more number of sharing times in multiple intelligent terminals means the higher usage hotness of the social networking application software.

In Step 320, the social networking application software is ranked based on the usage hotness, and an application list is formed;

When a sharing apparatus is used for the first time, the system is initialized. During initialization process, multiple social networking application software installed in the intelligent terminal are ranked according to usage hotness so as to form the application list after completion of the ranking, wherein, the application list can be invoked after a sharing control is clicked.

In Step 330, a request for sharing multimedia information is received from a user;

In Step 340, the number of sharing times of at least two social networking application software for sharing the multimedia information is acquired;

Step 350, the at least two social networking application software is ranked based on the number of sharing times of at least two social networking application software, and the application list is displayed for the user to select.

The implementation modes of steps 330 to 350 can be referred to above mentioned Embodiment 1.

In the technical solutions according to Embodiment 3 of this application, the social networking application software installed in the intelligent terminal are ranked according to usage hotness during initialization of the application list, and hence it is possible to facilitate the user to select the frequently-used social networking application software at a first time when used at an earlier time.

On the basis of the above technical solutions, after a new social networking application software is installed in the intelligent terminal, the application list can be updated based on usage hotness of the new social networking application software.

### Embodiment 4

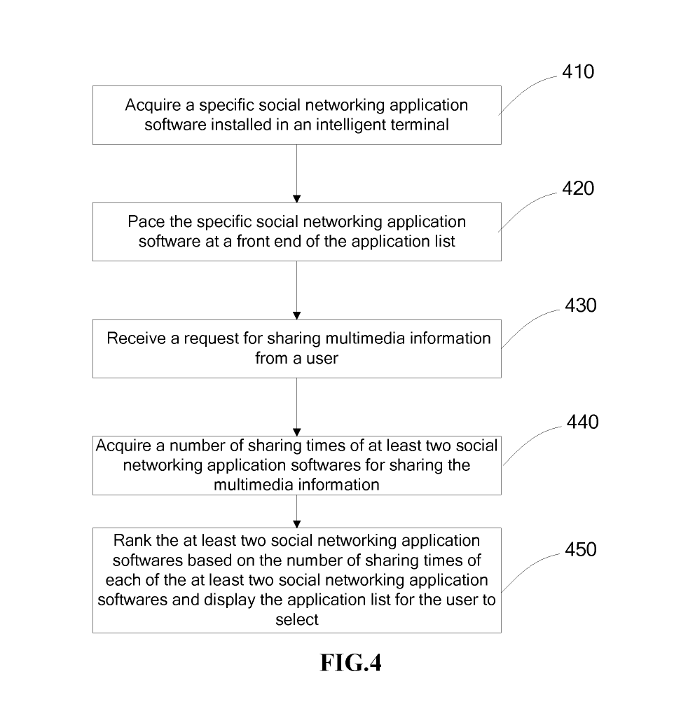

FIG. 4 is a schematic flowchart of a method for sharing multimedia information according to Embodiment 4 of this application, and the method includes:

In Step 410, a specific social networking application software installed in an intelligent terminal is acquired;

Particularly, when the initialization is executed or when a new social networking application software is installed, it is judged firstly whether the social networking application software is included in the specific social networking application software. The specific social networking application software includes Microblog, WeChat, QQ, and other user-defined social networking application software. The user-defined social networking application software can be the social networking application software pre-installed in the intelligent terminal, and recommended by a provider.

In Step 420, the specific social networking application software is placed at a front end of the application list;

In Step 430, a request for sharing multimedia information is received from a user;

In Step 440, the number of times of at least two social networking application software for sharing the multimedia information is acquired;

In Step 450, the at least two social networking application software is ranked based on the number of sharing times of at least two social networking application software, and the application list is displayed for the user to select, particularly, the specific social networking application software installed in the intelligent terminal is still placed at the front end of the application list.

In the technical solutions according to Embodiment 4 of this application, the application list can be changed according to installation or updating of the specific social networking application software, the specific social networking application software installed in the intelligent terminal is still placed at the front end of the application list, after ranking the social networking application software according to the number of sharing times, thereby guaranteeing that the user has a priority to see the above specific social networking application software during sharing, with more flexibility.

### Embodiment 5

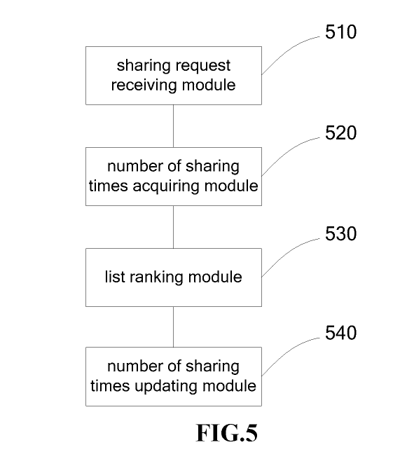

FIG. 5 is a structurally schematic diagram of an apparatus for sharing multimedia information according to Embodiment 5 of this application, optionally, as shown in FIG. 5, the sharing apparatus includes:

a sharing request receiving module 510, a number of sharing times acquiring module 520 and a list ranking module 530.

Particularly, the sharing request receiving module 510 is configured to receive a request for sharing multimedia information from a user;

the number of sharing times acquiring module 520 is configured to acquire number of sharing times of at least two social networking application software for sharing the multimedia information;

the list ranking module 530 is configured to rank the at least two social networking application software in an application list based on the number of sharing times of each of at least two social networking application software and display the application list for the user to select.

By adopting technical solutions according to Embodiment 5, social networking application software in the application list are ranked for selection by the user, based on the number of sharing times, solving the problem of being not flexible enough since the application list is fixed, when the user shares the multimedia information, so that the user can select frequently-used social networking application software at a first time, for sharing the multimedia information.

In the technical solution according to Embodiment 5 of this application, the sharing apparatus can further include a number of sharing times updating module 540, and the number of sharing times updating module 540 is configured to rank the at least two social networking application software based on the number of sharing times and then place the at least two social networking application software at the front end of the application list, for selection by the user, acquire the social networking application software selected by the user and add one to the number of sharing times of the social networking application software selected by the user.

Particularly, the list ranking module 530 is further configured to:

place the social networking application software having the number of sharing times greater than a preset threshold at a front end of the application list;

Before the sharing request of sharing multimedia information is received from the user, usage hotness of social networking application software installed in an intelligent terminal is acquired, and the social networking application software is ranked based on the usage hotness to form the application list. When the application list is initialized, the social networking application software installed in the intelligent terminal are ranked according to the usage hotness, it is possible to facilitate the user to select the frequently-used social networking application software at a first time when used at an earlier time.

Optionally, the list ranking module 530 is further configured to acquire usage hotness of social networking application software installed in an intelligent terminal, rank the social networking application software based on the usage hotness, and update the application list based on usage hotness of a new social networking application software after the new social networking application software is installed in the intelligent terminal.

Optionally, the list ranking module 530 is further configured to acquire a specific social networking application software installed in an intelligent terminal, and place the specific social networking application software at a front end of the application list, before receiving the sharing request of sharing multimedia information from the user, and the specific social networking application software includes at least one of Microblog, WeChat, QQ, and other user-defined social networking application software.

The apparatus for sharing multimedia information according to Embodiment 5 of this application can perform the sharing method according to any of the above embodiments, and have corresponding function modules and beneficial effects for performing the method.

### Embodiment 6

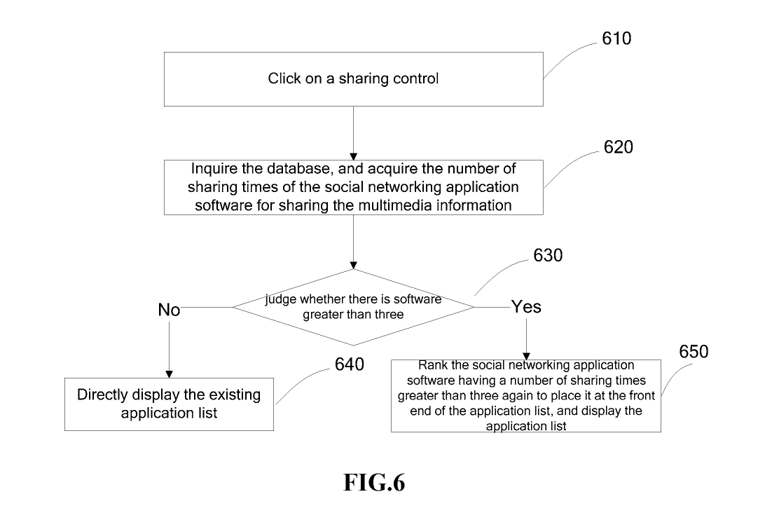

FIG. 6 is a schematic flowchart of a method for sharing multimedia information according to Embodiment 6 of this application. This embodiment provides an optional example, based on any of the above embodiments, including:

In Step 610, a sharing control is clicked;

An interface for sharing multimedia information includes the sharing control, and the user can click on the control to share the multimedia information.

In Step 620, the database is inquired, and the number of sharing times of the social networking application software for sharing the multimedia information is required.

After the user clicks on the sharing control, the number of sharing times of the social networking application software installed in the intelligent terminal for sharing the multimedia information can be obtained by inquiring the database.

In Step 630, it is judged whether there is software having a number of sharing times greater than three, if there is not software having a number of sharing times greater than three, step 640 is performed, otherwise, if there is software having a number of sharing times greater than three, step 650 is performed;

In Step 640, the existing application list is directly displayed;

In Step 650, if there is software having a number of sharing times greater than three, the social networking application software having a number of sharing times greater than three is ranked again to be placed at the front end of the application list, and the application list is displayed for the user to select.

By adopting technical solutions according to Embodiment 6, social networking application software in the application list are ranked for selection by the user, based on the number of sharing times, solving the problem of being not flexible enough since the application list is fixed, when the user shares the multimedia information, so that the user can select frequently-used social networking application software at a first time, for sharing the multimedia information.

### Embodiment 7

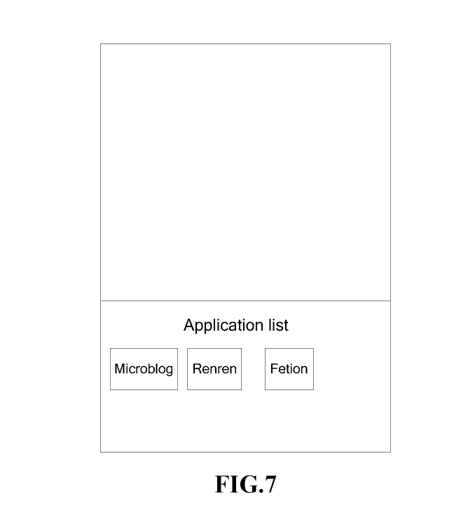

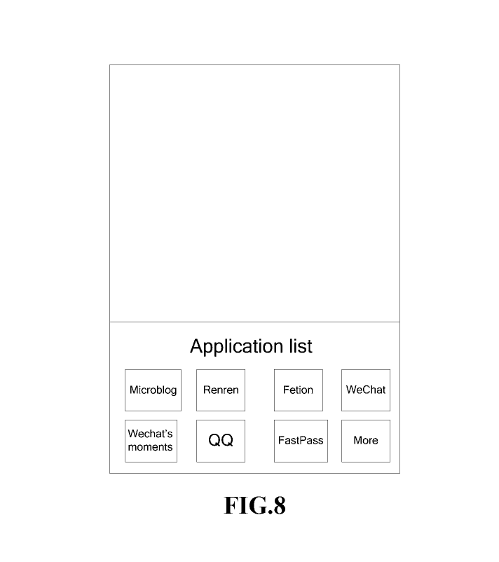

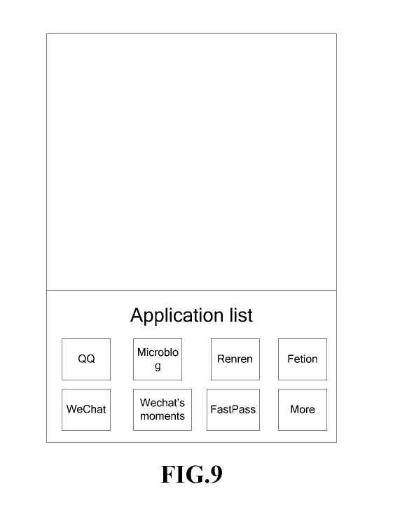

FIG. 7 is a schematic diagram of a first interface of an apparatus for sharing multimedia information according to Embodiment 7 of this application. As shown in FIG. 7, after completion of initialization, the user uses the apparatus for the first time to share the multimedia information, the social networking application software in the application list includes: Microblog, Renren and Fetion. The three types of social networking application software as shown in FIG. 7 are ranked according to usage hotness thereof. FIG. 8 is a schematic diagram of a second interface of an apparatus for sharing multimedia information according to Embodiment 7 of this application. As shown in FIG. 8, subsequent to installation of social networking application software, the icons of the social networking application software included in the application list also are increased accordingly, software, such as WeChat, Wechat's moments, QQ, FastPass are added. The subsequent social networking application software needs to be invoked by clicking more buttons, at this time, QQ is ranked at a position of the second row and the second column, as the number of sharing times of QQ increases subsequently, the social networking application software will be ranked again according to the number of sharing times when shared again. FIG. 9 is a schematic diagram of a third interface of an apparatus for sharing multimedia information according to Embodiment 7 of this application, as shown in FIG. 9, since the application list is ranked again according to the number of sharing times, the social networking application software QQ is ranked at the frontmost.

By adopting technical solutions according to Embodiment 7, social networking application software in the application list are ranked for selection by the user, based on the number of times, solving the problem of being not flexible enough since the application list is fixed, when the user shares the multimedia information, so that the user can select frequently-used social networking application software at a first time, for sharing the multimedia information.

### Embodiment 8

Embodiments of this application provide a non-transitory computer storage medium storing computer executable instructions for performing any of the above-described methods for sharing multimedia information in this application.

### Embodiment 9

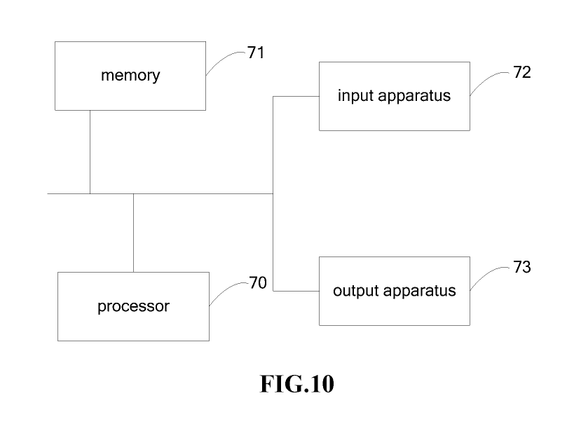

FIG. 10 is a schematic diagram showing the structure of hardware of an electronic device for performing a method for sharing multimedia information according to Embodiment 9 of this application, referring to FIG. 10, the electronic device includes:

one or more processors 70 and a memory 71, in FIG. 10, wherein one processor 70 is taken as an example;

The electronic device also can include: an input apparatus 72 and an output apparatus 73. The processor 70, the memory 71, the input apparatus 72 and the output apparatus 73 in the electronic device can be connected via a bus or by other means, in FIG. 10, the connection via a bus is taken as an example.

The memory 71, as a non-volatile computer-readable storage medium, can be used to store a non-volatile software program, a non-volatile computer-executable program and module, such as the program instruction/module corresponding to the method for sharing multimedia information according to embodiments of this application (for example, the sharing request receiving module 510, the number of sharing times acquiring module 520 and the list ranking module 530 as shown in FIG. 5). The processor 70 can perform functional applications and data processing in the server by running the software program, instruction and module stored in the memory 71, that is, the method for sharing multimedia information according to the above method embodiment can be implemented.

The memory 71 can include a storage program area and a storage data area, particularly, the storage program area can store an operating system and an application program required by at least one function; the storage data area can store data created by use of the terminal equipment. Besides, the memory 71 can include a high-speed random access memory, and also a non-volatile memory, such as at least one magnetic disk storage device, flash memory device or other non-volatile solid state storage device. In some examples, the memory 71 can include memories remotely located from the processor 70, these remote memories can connect to an intelligent terminal through the network. Examples of the above network include, but are not limited to, the Internet, an intranet, a local area network, a mobile communication network, and any combination thereof.

The input apparatus 72 can be configured to receive the input figure or character information, and generate key signal input associated with the user setting and functional control. The output apparatus 73 can include a display device, such as a display screen.

One or more modules are stored in the above memory 71, when one or more processors 70 are executed, steps of the method for sharing multimedia information according to any of the method embodiments are performed.

The above product can perform the method provided in the embodiments of this application, and have corresponding function modules and beneficial effects. Refer to the method provided in embodiments of this application for technical details, which are not described in detail in this embodiment.

The electronic device in the embodiments of this application can be found in many forms, including but not limited to:

1) a mobile communication device: such a device is featured by a mobile communication function and mainly directed to providing voice and data communication. This type of terminal includes: a smartphone (such as, IPHONE), a multimedia phone, a feature phone, a low-end phone, and etc.

2) a ultra-mobile personal computer device: such a device belongs to the category of personal computer, has a calculating and processing function, and generally has a mobile network access feature. This type of terminal includes: PDA, MID, UMPC device, and etc., such as IPAD.

3) a portable entertainment device: such a device can display and play multimedia contents. This type of device includes: an audio/video player (such as, IPOD), a hand-held gaming machine, an electronic book, an intelligent toy and a portable in-vehicle navigation device.

4) a server: a device for providing a computer service, the server is constructed of a processor, a hardware, a memory, a system bus, and etc., the server is similar to a general-purpose computer architecture, but has higher requirements on processing capability, stability, reliability, security, expandability and manageability, due to the requirement of providing highly reliable service.

5) other electronic apparatus having a data interaction function.

The embodiments of the device are exemplary only, the units described as separated parts can be or cannot be physically separated, and the parts shown as units can be or cannot be physical units, that is, the parts can be located in a place or distributed in multiple network units. Part or all of the modules of the device can be selected to achieve the purposes of the proposal of the embodiment according to the actual requirements. It can be understood and implemented by those of ordinary skill in the art without paying creative labor.

Through the description of the optional embodiments, it can be clearly understood by those of skill in the art that various embodiments can be realized by virtue of software plus necessary general-purpose hardware platforms and by virtue of hardware. Based on such understanding, the parts which substantially contribute to the existing art of the technical proposal can be embodied in the form of a computer software product, and the computer software product can be stored in computer-readable storage media such as an ROM/RAM, a disk, an CD, etc., and includes multiple instructions to instruct a computer equipment (which can be a personal computer, a server, network equipment, or the like) to execute each embodiment or the method described by some parts of the embodiment.

Finally, it should be noted that the above embodiments are merely provided for describing the technical solutions of this application, but not intended to limit this application. It should be understood by persons skilled in the art that although this application has been described in detail with reference to the foregoing embodiments, modifications can be made to the technical solutions described in the foregoing embodiments, or equivalent replacements can be made to some technical features in the technical solutions; however, such modifications or replacements do not cause the essence of corresponding technical solutions to depart from the scope of the embodiments of this application.

What is claimed is:

1. A method for sharing multimedia information, which is applied to a terminal, comprising:
receiving a request for sharing multimedia information from a user;
acquiring a number of sharing times of at least two social networking application software for sharing the multimedia information; and
ranking the at least two social networking application software in an application list based on the number of sharing times of each of the at least two social networking application software and displaying the application list for the user to select.

2. The method for sharing multimedia information according to claim 1, wherein, the ranking the at least two social networking application software in an application list, based on the number of sharing times of each of at least two social networking application software, comprises:
placing a social networking application software having the number of sharing times greater than a preset threshold at a front end of the application list.

3. The method for sharing multimedia information according to claim 1, wherein, after ranking the at least two social networking application software in the application list based on the number of sharing times of each of the at least two social networking application software and displaying the application list for the user to select, the method further comprises:
acquiring a social networking application software selected by the user;
adding one to the number of sharing times of the social networking application software selected by the user.

4. The method for sharing multimedia information according to claim 1, wherein, before receiving the request for sharing multimedia information from the user, the method further comprises:
acquiring usage hotness of social networking application software installed in an intelligent terminal;
ranking the social networking application software, based on the usage hotness, and forming the application list.

5. The method for sharing multimedia information according to claim 4, wherein, after ranking the social networking application software, based on the usage hotness, and forming the application list, the method further comprises:
after a new social networking application software is installed in the intelligent terminal, updating the application list based on usage hotness of the new social networking application software.

6. The method for sharing multimedia information according to claim 1, wherein, before receiving the request for sharing multimedia information from the user, the method further comprises:
acquiring a specific social networking application software installed in an intelligent terminal;
placing the specific social networking application software at a front end of the application list.

7. A non-transitory computer storage medium storing computer executable instructions, when executed by an electronic device, causes the electronic device to perform the following operations of:
receiving a request for sharing multimedia information from a user;
acquiring a number of sharing times of at least two social networking application software for sharing the multimedia information; and
ranking the at least two social networking application software in an application list based on the number of sharing times of each of the at least two social networking application software and displaying the application list for the user to select.

8. The non-transitory computer storage medium according to claim 7, wherein, the ranking the at least two social networking application software in an application list, based on the number of sharing times of each of the at least two social networking application software, comprise:
placing a social networking application software having the number of sharing times greater than a preset threshold at a front end of the application list.

9. The non-transitory computer storage medium according to claim 7, wherein, after ranking the at least two social networking application software in the application list based on the number of sharing times of each of the at least two social networking application software and displaying the application list for the user to select, further causing the electronic device to perform the following operations of:
acquiring a social networking application software selected by the user;
adding one to the number of sharing times of the social networking application software selected by the user.

10. The non-transitory computer storage medium according to claim 7, wherein, before receiving the request for sharing multimedia information from the user, further causing the electronic device to perform the following operations of:
acquiring usage hotness of social networking application software installed in an intelligent terminal;
ranking the social networking application software, based on the usage hotness, and forming the application list.

11. The non-transitory computer storage medium according to claim 10, wherein, after ranking the social networking application software, based on the usage hotness, and forming the application list, further causing the electronic device to perform the following operations of:
after a new social networking application software is installed in the intelligent terminal, updating the application list based on usage hotness of the new social networking application software.

12. The non-transitory computer storage medium according to claim 7, wherein, before receiving the request for sharing multimedia information from the user, further causing the electronic device to perform the following operations of:
acquiring a specific social networking application software installed in an intelligent terminal;
placing the specific social networking application software at a front end of the application list.

13. An electronic device, comprising:
at least one processor, and
a memory communicably connected with the at least one processor and for storing instructions executable by the at least one processor,
wherein execution of the instructions by the at least one processor causes the at least one processor to perform the following operations of:
receiving a request for sharing multimedia information from a user;
acquiring a number of sharing times of at least two social networking application software for sharing the multimedia information; and
ranking the at least two social networking application software in an application list based on the number of sharing times of each of the at least two social networking application software and displaying the application list for the user to select.

14. The electronic device according to claim 13, wherein, the ranking the at least two social networking application software in an application list, based on the number of sharing times of each of at least two social networking application software, comprises:
placing a social networking application software having the number of sharing times greater than a preset threshold at a front end of the application list.

15. The electronic device according to claim 13, wherein, after ranking the at least two social networking application software in the application list based on the number of sharing times of each of the at least two social networking application software and displaying the application list for the user to select, further causing the at least one processor to perform the following operations of:
acquiring a social networking application software selected by the user;
adding one to the number of sharing times of the social networking application software selected by the user.

16. The electronic device according to claim 13, wherein, before receiving the request for sharing multimedia information from the user, further causing the at least one processor to perform the following operations of:
acquiring usage hotness of social networking application software installed in an intelligent terminal;
ranking the social networking application software, based on the usage hotness, and forming the application list.

17. The electronic device according to claim 16, wherein, after ranking the social networking application software, based on the usage hotness, and forming the application list, further causing the at least one processor to perform the following operations of:
after a new social networking application software is installed in the intelligent terminal, updating the application list based on usage hotness of the new social networking application software.

18. The electronic device according to claim 13, wherein, before receiving the request for sharing multimedia information from the user, further causing the at least one processor to perform the following operations of:
acquiring a specific social networking application software installed in an intelligent terminal;
placing the specific social networking application software at a front end of the application list.
